(19) United States
(12) Patent Application Publication
(10) Pub. No.: US 2025/0317300 A1
(43) Pub. Date: Oct. 9, 2025

(54) SYSTEM AND METHOD FOR PERFORMING MULTICAST AUTHENTICATION IN NETWORK-ON-CHIP SYSTEMS

(71) Applicant: University of Florida Research Foundation, Incorporated, Gainesville, FL (US)

(72) Inventors: Prabhat Kumar Mishra, Gainesville, FL (US); Hansika M Weerasena Loku Kattadige, Gainesville, FL (US)

(21) Appl. No.: 19/025,063

(22) Filed: Jan. 16, 2025

Related U.S. Application Data
(60) Provisional application No. 63/573,708, filed on Apr. 3, 2024.

(51) Int. Cl. H04L 9/32; H04L 9/08

(52) U.S. Cl. CPC H04L 9/3242; H04L 9/0819

(57) ABSTRACT

A method and system are directed to securing multicast communications, the method comprises receiving a message payload, initializing a multicast message authentication code (MAC) tag, generating a first-format tag based on a hash of a pre-shared symmetric key and the message payload, generating a second-format tag based on a bit extension of the first-format tag, generating a transformed tag based on a bit length transformation of the second-format tag, accumulating the transformed tag to the multicast MAC tag, and generating a multicast authenticated packet based on the multicast MAC tag.

### CROSS REFERENCE TO RELATED APPLICATION

This application claims the priority of U.S. Provisional Application No. 63/573,708, entitled “SYSTEM AND METHOD FOR PERFORMING MULTICAST AUTHENTICATION IN NETWORK-ON-CHIP SYSTEMS,” filed on Apr. 3, 2024, the disclosure of which is hereby incorporated by reference in its entirety.

### GOVERNMENT SUPPORT

This invention was made with government support under 1936040 awarded by the National Science Foundation. The government has certain rights in the invention.

### TECHNICAL FIELD

Various embodiments of the present disclosure relate to multicast communication, and more particularly to performing multicast authentication in network-on-chip (NoC) systems.

### BACKGROUND

Network-on-chips (NoC) may be used to manage communications in system-on-chips (SoCs). The ubiquity of a NoC and its distributed nature across a chip has made it a focal point of attacks. Spoofing attacks by impersonating nodes in a SoC may lead to unauthorized information access and may be employed to launch denial of service attacks. As modern software trends towards using parallelism among multiple cores, multicast communication among cores may be heavily used to exchange cache coherence messages. However, traditional multicast authentication solutions are not effective or suitable for use in NoC-based SoCs due to resource-constraints.

### BRIEF SUMMARY

Various embodiments described herein relate to methods, apparatus, systems, computing devices, computing entities, and/or the like for authenticating multicast communications. According to some embodiments, a method for securing multicast communications is provided. In some embodiments, the method comprises receiving, by one or more processors, a message payload; initializing, by the one or more processors, a multicast message authentication code (MAC) tag; generating, by a network interface, a first-format tag based on a hash of a pre-shared symmetric key and the message payload; generating, by the network interface, a second-format tag based on a bit extension of the first-format tag; generating, by the network interface, a transformed tag based on a bit length transformation of the second-format tag; accumulating, by the network interface, the transformed tag to the multicast MAC tag; and generating, by the network interface, a multicast authenticated packet based on the multicast MAC tag.

In some embodiments, the message payload comprises a cache invalidation message. In some embodiments, initializing the multicast MAC tag comprises generating a bit string of ones (1's) that comprises a length of r. In some embodiments, the multicast MAC tag comprises an accumulated hash. In some embodiments, the multicast MAC tag comprises a one-way hash function with a quasi-commutative property. In some embodiments, the multicast MAC tag comprises a fast variant of a one-way accumulator. In some embodiments, the hash comprises a keyed hash function. In some embodiments, the pre-shared symmetric key is associated with a multicast sender and a multicast receiver. In some embodiments, generating the second-format tag further comprises extending the first-format tag by mapping the first-format tag to the second-format tag based on one or more values that are generated by one or more pseudorandom number generators. In some embodiments, generating the transformed tag further comprises replacing all-zero sub-strings in the second-format tag with zero (0) and replacing non-all-zero sub-strings in the second-format tag with 1. In some embodiments, accumulating the transformed tag to the multicast MAC tag further comprises applying a bitwise logical and operation. In some embodiments, accumulating the transformed tag to the multicast MAC tag further comprises combining the transformed tag with a plurality of transformed tags that are associated with a plurality of multicast receivers. In some embodiments, combining the transformed tag with the plurality of transformed tags further comprises generating a collective product of the transformed tag and the plurality of transformed tags. In some embodiments, generating the multicast authenticated packet comprises concatenating the message payload with the multicast MAC tag.

According to some embodiments a method for verifying authenticity of multicast communications is provided. In some embodiments, the method comprises parsing, by the network interface, a message payload and a multicast message authentication code (MAC) tag from a multicast authenticated packet; generating, by the network interface, a first-format tag based on a hash of a pre-shared symmetric key and the message payload; generating, by the network interface, a second-format tag based on a bit extension of the first-format tag; generating, by the network interface, a transformed tag based on a bit length transformation of the second-format tag; and determining, by the network interface, authenticity of the multicast authenticated packet based on a comparison of an accumulation comprising the transformed tag and the multicast MAC tag with the multicast MAC tag. In some embodiments, determining the authenticity of the multicast authenticated packet further comprises determining the multicast authenticated packet is valid based on a presence of the accumulation in the multicast MAC tag. In some embodiments, determining the authenticity of the multicast authenticated packet further comprises determining the multicast authenticated packet is invalid.

According to some embodiments a multicast authentication system comprises a system-on-chip device comprising a source node configured to generate one or more message payloads; a tag generator configured to generate one or more multicast authenticated packets based on the one or more message payloads and a pre-shared symmetric key; a network-on-chip comprising one or more routers; one or more destination nodes; and one or more tag verifiers configured to (i) receive the one or more multicast authenticated packets via the one or more routers, (ii) verify the one or more multicast authenticated packets, and (iii) provide the verified one or more multicast authenticated packets to the one or more destination nodes.

In some embodiments, the one or more message payloads comprise one or more cache invalidation messages. In some embodiments, the one or more multicast authenticated packets comprise one or more multicast message authentication code (MAC) tags.

### BRIEF DESCRIPTION OF THE DRAWINGS

Embodiments incorporating teachings of the present disclosure are shown and described with respect to the figures presented herein.

FIG. 1 depicts an example architecture of a NoC-based system.

FIG. 2 depicts an example architecture in a scenario that is representative of a NoC-based system that has been comprised with a malicious router.

FIG. 3 depicts a schematic diagram of a multicast authentication system in accordance with various embodiments of the present disclosure.

FIG. 4 depicts a flowchart of an example process securing multicast communications in accordance with some embodiments of the present disclosure.

FIG. 5 depicts a flowchart diagram of an example process for verifying authenticity of multicast communications in accordance with some embodiments of the present disclosure.

FIG. 6 depicts an example architecture for pipelining operations associated generating a first-format tag and a second-format tag in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The advancement of manufacturing technologies has enabled the integration of a plurality of diverse intellectual property (IP) cores on a single system-on-chip (SoC). As an example, a multiprocessor SoC (MPSoC) may comprise a large number of computing cores that support parallel computation and multiprogramming workloads. Due to a steady increase in the number of cores in MPSoCs, parallel programming may be used to improve applications that may exploit parallelism. However, parallel workloads may lead to increased one-to-many (e.g., multicast) communications inside MPSoCs. In particular, NoCs may treat multicast traffic patterns as repeated unicast traffic (e.g., software multicast), which may lead to hotspots and performance bottlenecks in NoCs.

Network-on-chips (NoCs) may be used to provide communication infrastructure in MPSoCs. For example, a NoC may be used for communicating cache coherence and other control messages between processors and memory subsystems. Given that a NoC may access every component in a SoC, NoCs may be a focal point of attackers. Additionally, in a spoofing attack, a malicious node may impersonate a node to violate the security of a SoC. Thus, ensuring authenticity against spoofing attacks may be a critical security concern in NoCs. Additionally, due to cost and time-to-market constraints, third-party IP blocks may be used in designing SoCs. However, third-party IPs pose security concerns as they may come with malicious implants, hidden backdoors, and undocumented bugs. Long supply chains and potentially untrusted vendors may further increase security concerns in SoCs.

Traditional unicast security solutions for authentication may not be suitable for multicast communications in SoCs due to the use of shared or secret keys between source and destination nodes. Moreover, traditional multicast authentication solutions used in traditional computer networks may not be suitable for NoCs due to resource constraints of NoCs.

As described above, there are many technical challenges and difficulties associated with securing NoC-based systems, such as in SoCs. Various example embodiments of the present disclosure overcome such technical challenges and difficulties in NoC-based systems and provide various technical advancements and improvements. According to various embodiments of the present disclosure, methods and systems are provided for multicast packet authentication in NoCs. In particular, some embodiments comprise a multicast authentication scheme that utilizes a unicast authentication infrastructure. The disclosed multicast authentication may provide reconfigurable security that comprises minimal performance and area overhead. In doing so, the techniques described herein improve security and speed of securing multicast communications using NoCs in SoCs or NoC-based systems.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRam), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture

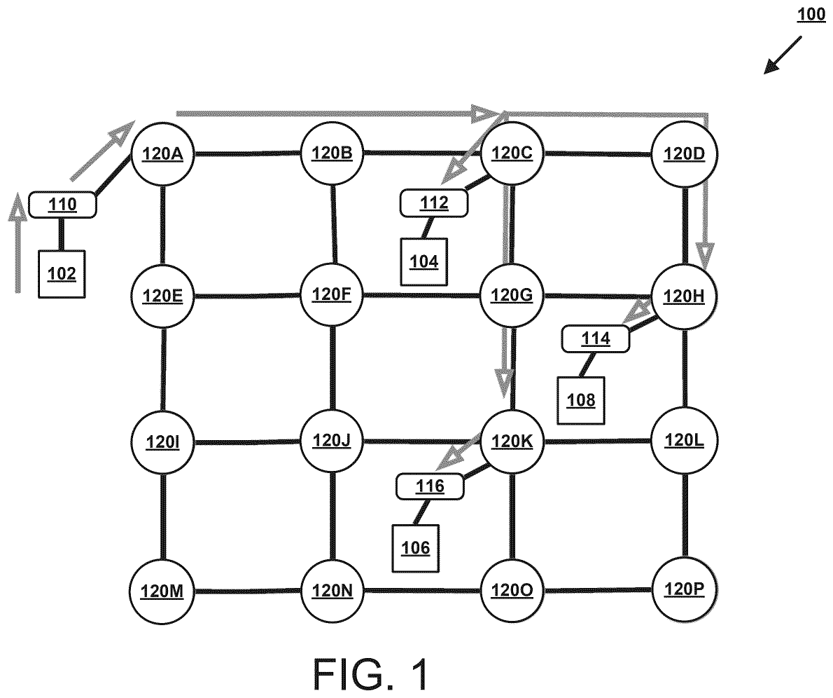

FIG. 1 depicts an example architecture 100 of a NoC-based system (e.g., a NoC-based SoC).

In some embodiments, a NoC may refer to a network-based communications subsystem that is configured on an integrated circuit. For example, a NoC may comprise a router-based packet switching network that is configured between modules in a SoC to perform on-chip communications between the modules. In some embodiments, a SoC may refer to an integrated circuit or device that combines a plurality of computer or electronic components (e.g., subsystems) onto a single chip.

The architecture 100 includes a source IP core node 102 that may be configured to communicate multicast packets to a plurality of destination IP core nodes 104, 106, and 108. In some embodiments, an IP core node (such as source IP core node 102 and/or destination IP core nodes 104, 106, and/or 108) comprises a reusable unit of logic, cell, or integrated circuit layout design that is associated with intellectual property of a party (e.g., a third-party manufacture). Multicast packets from source IP core node 102 may be routed through a network of routers 120A-P by a network interface 110 based on, for example, a tree-based multicast routing scheme. As depicted in FIG. 1, multicast packets traverse through nodes of routers 120A, 120B, 120C, 120D, 120G, 120H, and 120K in example paths (depicted with arrows). Multicast packets may follow a single path and/or branch out as necessary (e.g., at router 120C). The multicast packets may be received by destination IP core nodes 104, 106, and 108 via network interfaces 112, 114, and 116, respectively.

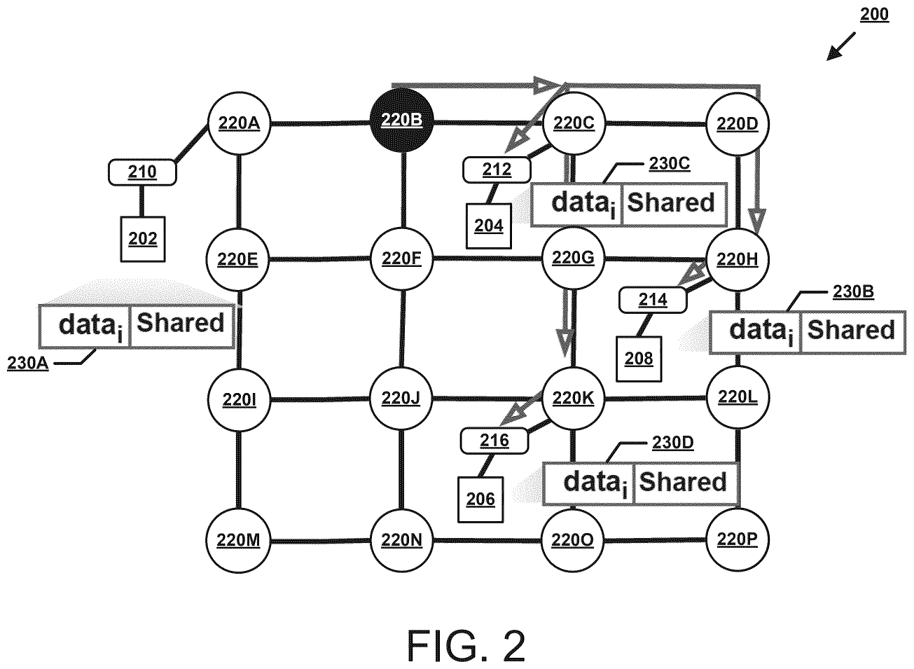

In directory-based cache coherence protocols, multicast packets may comprise cache invalidation messages. Cache invalidation messages may comprise short control messages that are sent from the owner of cache data to all the IP cores that are sharing the cache data. However, one or more routers may comprise malicious routers with hardware trojans that may impersonate nodes and send fake cache invalidation messages, as depicted in FIG. 2.

FIG. 2 depicts an example architecture 200 in a scenario that is representative of a NoC-based system that has been comprised with a malicious router. Multicast packets from source IP core node 202 may be routed through a network of routers 220A-P by a network interface 210. As depicted in FIG. 2, fake cache invalidation messages are provided to nodes of routers 220C, 220D, 220G, 220H, and 220K (shown by the arrows) by a malicious router 220B impersonating a cache block owner (source IP core node 202) that is coupled to a network interface 210 and comprising shared data 230A. The fake cache invalidation messages may be received by destination nodes 204, 206, or 208 via network interfaces 212, 214, and 216, respectively, and cause invalidation of shared data 230B, 230C, and 230D in cache blocks used by destination nodes 204, 206, and 208, respectively. As such, application execution may be halted due to an invalidated cache block. An invalidated cache block may also result in performance degradation. For example, when the shared data 230B, 230C, or 230D in the cache blocks of destination nodes 204, 206, or 208, respectively, are invalidated, the destination nodes 204, 206, and 208 may send read requests to reacquire the cache blocks, resulting in increased traffic. Thus, data traffic hotspots may occur around source IP core node 202 as a result of simultaneous read requests from destination nodes 204, 206, and 208. Therefore, authenticating cache invalidation packets may prevent malicious attacks caused by spoofing of fake cache invalidation messages.

According to various embodiments of the present disclosure, an authentication scheme is provided that comprises unicast authentication. In some embodiments, the authentication scheme assumes that network interfaces of a NOC-based system are trustworthy. In some embodiments, unicast authentication is performed at network interfaces based on a hash function, such as SipHash. In some embodiments, performing the unicast authentication comprises generating a message authentication code based on a shared key between a sender and a receiver and validating authenticity of the message based on the shared key.

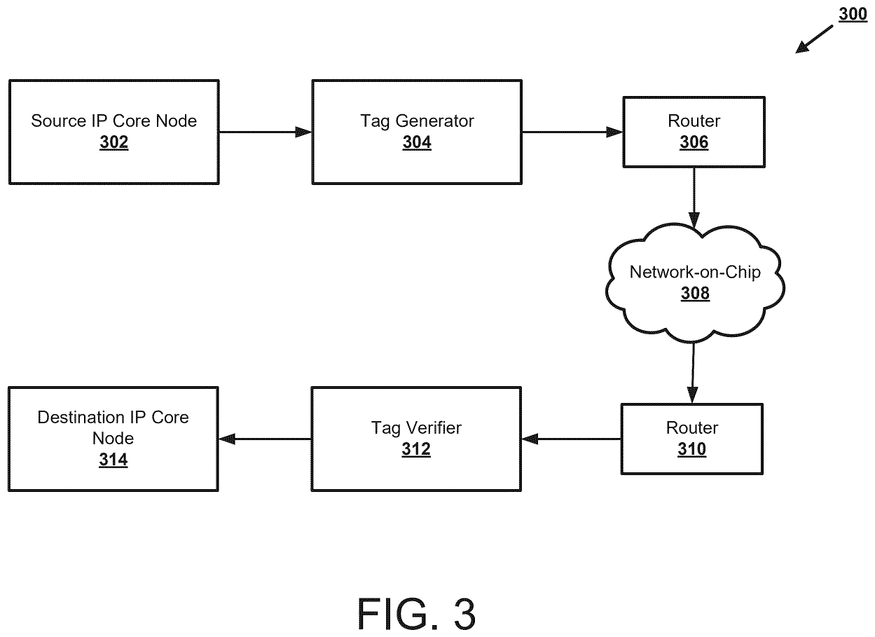

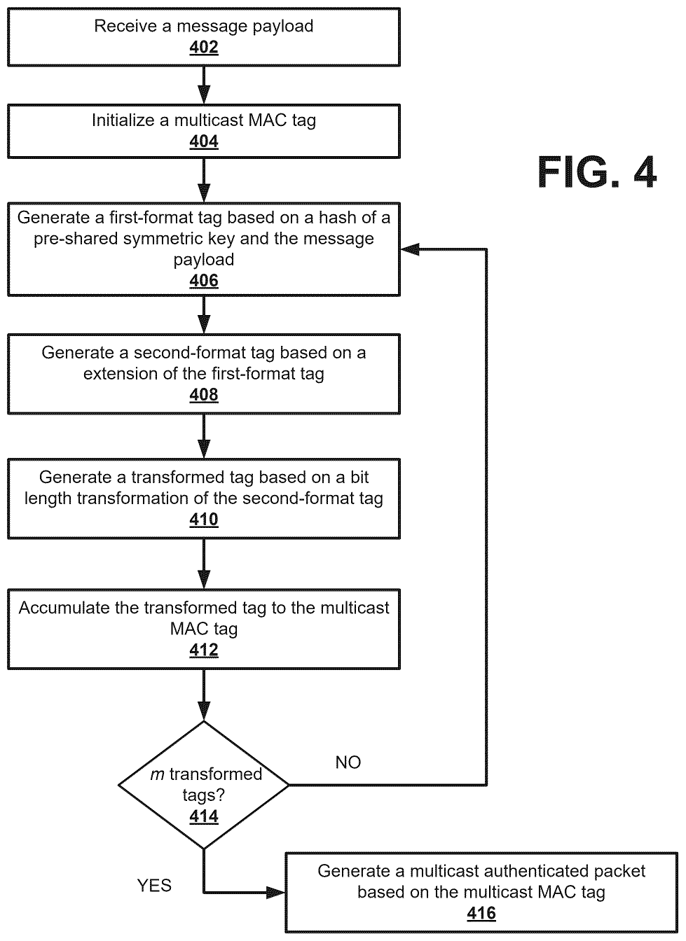

FIG. 3 is a schematic diagram of a multicast authentication system 300 in accordance with various embodiments of the present disclosure. As depicted in FIG. 3, the multicast authentication system 300 comprises a source IP core node 302 that may be configured to generate and transmit message payloads for communicating control information (e.g., cache invalidation messages) to one or more of destination IP core node 314. The source IP core node 302 is coupled to a tag generator 304. Tag generator 304 may be configured to receive the message payloads generated and transmitted by the source IP core node 302 and generate multicast authenticated packets that comprise multicast message authentication code (MAC) tags based on the message payloads and a pre-shared symmetric key. In some embodiments, the tag generator 304 comprises a network interface. Generating the multicast MAC tags and functionalities provided by the tag generator 304 are described in further detail with reference to FIG. 4.

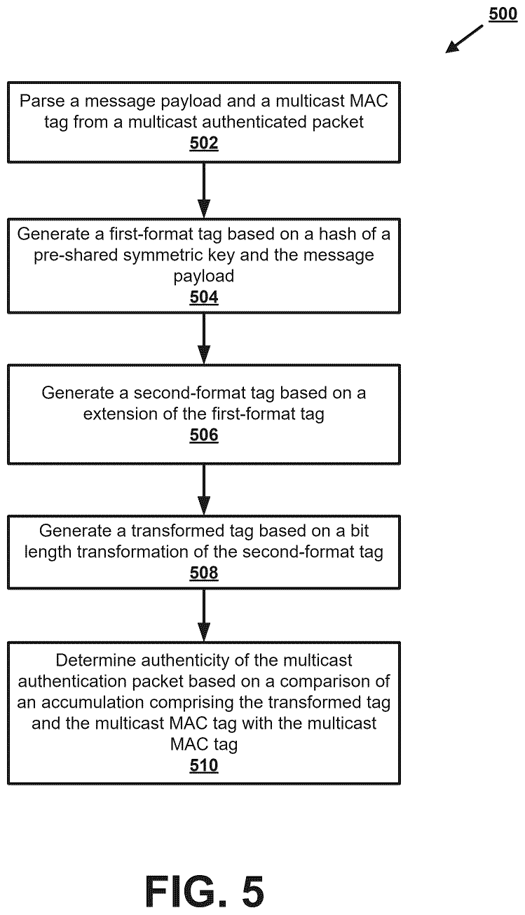

Multicast authenticated packets generated by the tag generator 304 may be transmitted to destination IP core node 314 by traversing through a path of nodes in network-on-chip 308 between router 306 and router 310. A tag verifier 312, that is coupled to the destination IP core node 314, may be configured to receive and authenticate the multicast authenticated packets by verifying multicast MAC tags in the multicast authenticated packets. In some embodiments, verified multicast authenticated packets are provided to the destination IP core node 314 while unverified multicast authenticated packets are flagged, discarded, or ignored. In some embodiments, the tag verifier 312 comprises a network interface. Verifying the multicast MAC tags and functionalities provided by the tag verifier 312 are described in further detail with reference to FIG. 5.

### Example System Operations

Various embodiments of the present disclosure describe steps, operations, processes, methods, functions, and/or the like for authenticating multicast communications.

FIG. 4 is a flowchart of an example process 400 for securing multicast communications in accordance with some embodiments of the present disclosure. The process 400 includes example operations that may be performed by an apparatus, such as a SoC or a component of a SoC. In some embodiments, the apparatus comprises means, such as processing elements, non-volatile memory, volatile memory, network interface(s), and/or the like, for performing the example operations. In some embodiments, via the various steps/operations of the process 400, the apparatus provides an authentication mechanism for securing multicast packets.

In some embodiments, the process 400 begins at step/operation 402 when the apparatus receives a message payload M. The message payload M may comprise a control message, such as a cache invalidation message, that is generated by a multicast sender s (e.g., source IP core node 302) and transmitted for receipt by m number of multicast receivers (e.g., destination IP core node 314).

In some embodiments, at step/operation 404, the apparatus initializes a multicast MAC tag. For example, initializing a multicast MAC tag Tg may comprise generating a bit string of length of r. The bit string may comprise a sequence of binary digits of a predetermined value. For example, a bit string may comprise a string of ones (1's) (e.g., every bit of the bit string is a ‘1’). In some embodiments, the multicast MAC tag comprises an accumulated hash. In some embodiments, accumulated hashing describes a process where items are cumulatively hashed together, and afterwards, each item may separately prove its membership in the accumulation. For example, data objects or values may be combined and hashed into an accumulated hash where each data object or value of the accumulated hash may prove their membership in the accumulated hash. The order in which items are hashed may not affect the value of an accumulated hash.

In some embodiments, at step/operation 406, the apparatus generates, via a network interface (e.g., comprising a tag generator 304), a first-format tag based on a hash of a pre-shared symmetric key and the message payload M. According to various embodiments of the present disclosure, the hash is generated with respect to a multicast receiver and the pre-shared symmetric key may be associated with the multicast receiver. In some embodiments, the hash comprises a SipHash. The SipHash may comprise a keyed hash function, where the multicast sender s provides, as inputs to the SipHash, (i) a pre-shared symmetric key (k_{S,i}) between the multicast sender s and a multicast receiver i of the message payload M and (ii) the message payload M.

In some embodiments, at step/operation 408, the apparatus generates, via the network interface, a second-format tag based on a bit extension of the first-format tag. For example, the first-format tag may comprise a first size format (e.g., 64 bits) that may be extended bitwise into a second size format that is longer than the first size format. According to various embodiments of the present disclosure, the second-format tag comprises a l length random bit string format. In some embodiments, length l=r×d, where r may comprise an integer representing a length of an accumulated hash value and d=log₂(N), where N may represent an upper bound of a number of possible accumulated items. In some embodiments, a bit extension operation comprises mapping bits of the first-format tag to a second size format by appending values generated by one or more pseudorandom number generators prng to the bits. In some embodiments, the first-format tag is provided as a seed to the one or more pseudorandom number generators prng.

In some embodiments, at step/operation 410, the apparatus generates, via the network interface, a transformed tag based on a bit length transformation of the second-format tag. A bit length transformation αᵣ may receive as input the second-format tag of length/and output a transformed tag of length r. The bit length transformation αᵣ may interpret the second-format tag as r of d length sub-strings by replacing all-zero sub-strings with a ‘0’ and non-all-zero sub-strings with a ‘1.’ For example, a second-format tag comprising a bit string yᵢ (that is generated from a first-format tag that comprises bit strings y₁, . . . , yₘ) may be represented as yᵢ=(y_{i,1}, . . . , y_{i,r}), where for each yᵢⱼ, if yᵢⱼ={0}^{d}, yᵢⱼ is replaced by ‘0,’ otherwise yᵢⱼ is replaced by ‘1.’

At step/operation 412, the apparatus accumulates, via the network interface, the transformed tag to the multicast MAC tag. In some embodiments, accumulating the transformed tag to the multicast MAC tag comprises hashing the multicast MAC tag with the transformed tag. In some embodiments, the transformed tag is cumulatively hashed with transformed tags from previous iterations (e.g., for the m number of multicast receivers) of step/operation 412. For example, a cryptographically secure hash function h comprising a tag length of l may be represented as {0,1}*→{0,1}¹ and if X=xₗ, . . . , xₘ represents a set of items (e.g., transformed tags) to be accumulated where a number of multicast destinations m≤N, then

$${y}_{i} = h ( {x}_{i} ) , i = 1 … m \qquad Equation 1$$

In some embodiments, accumulating the transformed tag to the multicast MAC tag comprises cumulatively hashing the transformed tag with an accumulated hash of a plurality of transformed tags (via the multicast MAC tag) that are associated with the m number of multicast receivers. For example, a transformed tag may be combined and/or hashed with other transformed tags generated in previous iterations as well as subsequent iterations of step/operation 412 performed for the m number of multicast receivers. In some embodiments, the transformed tag is accumulated to the multicast MAC tag by applying a bitwise logical AND operation. In some embodiments, accumulating the transformed tag to the multicast MAC tag comprises generating a collective product of a plurality of transformed tags for the m number of multicast receivers.

In some embodiments, a one-way accumulator is used to accumulate the transformed tag into the multicast MAC tag. A one-way accumulator may comprise a one-way hash function with a quasi-commutative property. That is, a function f: A×B→A may be quasi-commutative if for all a∈A, and for all b, c∈B:

$$f ( f ( a , b ) , c ) = f ( f ( a , c ) , b ) \qquad Equation 2$$

where the value a may represent a seed and the order of accumulation of the items does not affect a final hash.

In some embodiments, the multicast MAC tag is accumulated with a fast variant of a one-way accumulator, which may be determined by:

$$Tg = H ( s , X ) = s ⊙ {\prod }_{i = 1}^{m} {α}_{r} ( h ( {x}_{i} ) ) \qquad Equation 3$$

where s may represent a seed value, ⊙ may represent a bitwise AND operator, and Π may represent a bitwise product operator. As such, a fast accumulation of a multicast MAC tag Tg may be expressed as the following:

$$Tg = {\{ 1 \}}^{r} {\prod }_{i = 1}^{m} {α}_{r} ( prng ( SipHash ( {k}_{s , i} , M ) ) ) \qquad Equation 4$$

In some embodiments, at step/operation 414, the apparatus determines, via the network interface, if the multicast MAC tag comprises m number of transformed tags that are associated with the m number of multicast receivers.

In some embodiments, if the multicast MAC tag does not comprise m number of transformed tags, the process 400 repeats steps/operations 406 through 412 until m number of transformed tags have been generated.

In some embodiments, if the multicast MAC tag comprises m number of transformed tags, at step/operation 416, the apparatus generates, via the network interface, a multicast authenticated packet based on the multicast MAC tag. In some embodiments, generating a multicast authenticated packet pkt comprises concatenating the message payload M with the multicast MAC tag Tg. Thus, by transmitting data (e.g., message payload M) via a multicast authenticated packet (e.g., multicast authenticated packet pkt), a multicast MAC tag (e.g., multicast MAC tag Tg) may provide multicast authentication of the message payload M when received by one or more multicast receivers.

An example algorithm for securing messages (e.g., multicast communications) with multicast MAC tags in accordance with some embodiments of the present disclosure is provided below:

| Input: {M, kₛ,₁ . . . k_{s,m}} | |
|---|---|
| Output: multicast authenticated packet | |
| T_{g} ← {1}^{r} | |
| for i=1 to m do | |
| tag ← siphash(k_{s,i}, M) | |
| ltag ← prng(tag) | |
| Tg ← Tg ⊙ αᵣ(ltag) | |
| pkt ← M\|\|T_{g} | // where \|\| represents a concatenation operator |

Return pkt

An example algorithm for performing a bit length transformation in accordance with some embodiments of the present disclosure is provided below:

```
Input: bit sequence in ∈ {0, 1}^{l}
Output: bit sequence out ∈ {0, 1}^{r}
Parse in as yₗ|| . . . ||yᵣ where length(yⱼ) = d
out ← empty bit sequence
for j=1 to r do
  if yⱼ = {0}^{d} then
    out ← out||0
  else
    out ← out||1
return out
```

FIG. 5 is a flowchart diagram of an example process 500 for verifying authenticity of multicast communications in accordance with some embodiments of the present disclosure. The process 500 includes example operations that may be performed by an apparatus, such as a SoC or a component of a SoC. In some embodiments, the apparatus comprises means, such as processing elements, non-volatile memory, volatile memory, network interface, and/or the like, for performing the example operations.

In some embodiments, the process 500 begins at step/operation 502 when the apparatus, via a network interface (e.g., comprising a tag verifier 312), parses a message payload and a multicast MAC tag from a multicast authenticated packet. For example, a multicast authenticated packet pkt may be received by a multicast receiver i (e.g., a destination IP core node 314) from a multicast sender s (e.g., a source IP core node 302) and comprise a message payload M and a multicast MAC tag Tg′. The multicast authenticated packet pkt may be parsed to separate out the message payload M and the multicast MAC tag Tg′.

In some embodiments, at step/operation 504, the apparatus, via the network interface, generates a first-format tag based on a hash of a pre-shared symmetric key and the message payload. In some embodiments, the hash comprises a SipHash. The SipHash may comprise a keyed hash function that is provided with, as inputs to the SipHash, (i) a pre-shared symmetric key (k_{S,i}) between the multicast sender s and the multicast receiver i and (ii) the message payload M.

In some embodiments, at step/operation 506, the apparatus, via the network interface, generates a second-format tag based on a bit extension of the first-format tag. For example, the first-format tag may comprise a first size format (e.g., 64 bits) that may be extended bitwise into a second size format that is longer than the first size format. According to various embodiments of the present disclosure, the second-format tag comprises a l length random bit string format. In some embodiments, length l=r×d, where r may comprise an integer representing a length of an accumulated hash value and d=log₂(N), where N may represent an upper bound of a number of possible accumulated items in a one-way accumulator. In some embodiments, a bit extension operation comprises mapping bits of the first-format tag to a second size format by appending values generated by one or more pseudorandom number generators prng to the bits. In some embodiments, the first-format tag is provided as a seed to the one or more pseudorandom number generators prng.

In some embodiments, at step/operation 508, the apparatus, via the network interface, generates a transformed tag based on a bit length transformation of the second-format tag. A bit length transformation αᵣ may receive as input the second-format tag of length l and output a transformed tag of length r. The bit length transformation αᵣ may interpret the second-format tag as r of d length sub-strings by replacing all-zero sub-strings with a ‘0’ and non-all-zero sub-strings with a ‘1.’ For example, a second-format tag comprises a bit string yᵢ that is generated from a first-format tag that comprises bit strings y₁, . . . , yₘ may be represented as yᵢ=(y_{i,1}, . . . , y_{i,r}), and for each yᵢⱼ, if yᵢⱼ={0}^{d}, yᵢⱼ is replaced by ‘0,’ otherwise yᵢⱼ is replaced by ‘1.’

In some embodiments, at step/operation 510, the apparatus, via the network interface, determines authenticity of the multicast authenticated packet based on a comparison of an accumulation of the transformed tag to the multicast MAC tag, with the multicast MAC tag. Details of performing an accumulation is described above regarding the description of step/operation 412. The accumulation of the transformed tag to the multicast MAC tag (parsed from the multicast authenticated packet) may be compared with the multicast MAC tag itself to determine if the accumulation is present in the multicast MAC tag. If the accumulation is present in the multicast MAC tag, then the multicast authenticated packet may be determined as valid. Otherwise, if the accumulation is not present in the multicast MAC tag, then the multicast authenticated packet may be determined as invalid or as a communication packet that has been spoofed.

An example algorithm for authenticating messages (e.g., multicast communications) in accordance with some embodiments of the present disclosure is provided below:

Input: {pkt, k_{s,i}}
Output: authenticity of the packet
parse pkt as M||Tg′
tag ← siphash(k_{s,i}, M)
ltag ← prng(tag)
if αr(ltag) ⊙ Tg′ is Tg′ then
valid pkt
else
spoofed pkt

### Example Security Analysis

A unicast message authentication code may comprise the property of unforgeability to provide security. Similarly, if a hash function is proven to be secure, it cannot be forged. As such, a cryptographically secure hash function (e.g., SipHash), as disclosed herewith, may rely on the aforementioned security properties. In particular, if the pseudorandom number generator prng uses a SipHash (e.g., first-format) tag as a seed, a l length (e.g., second-format) tag may not be forged. Therefore, individual accumulated hashes generated based on the l length tag also may not be forged.

In an example where a validation of authenticity of an accumulated hash (e.g., a multicast MAC tag) is performed based on a bitwise logical AND operation (⊙), an attacker may send a forged accumulated signature with a large number of zeros (0's) to increase the probability of validation. For example, if a multicast MAC tag is Tg=11001000, bit length transformation αᵢ is 11101100, and if an adversary used all zero {0}⁸ as a forged multicast MAC tag (Tg′), the forged multicast MAC tag will be verified because {0}⁸⊙αᵢ={0}⁸. Therefore, an upper bound on number of zeros (0's) in Tg may be defined depending on a security requirement t. On the other hand, a lower bound on number of ones (1's) to be on a valid Tg may also be defined.

In another example where the number of ones in an r-length accumulated hash is z, the bit composition of a final accumulated multicast MAC tag may be considered as a binomial distribution associated with two possible outcomes: (a) a bit being one (1) and (b) a bit being zero (0). A discrete random variable Z may be defined as the number of ones (1's) in a multicast MAC tag Tg. Then the probability of having z ones in a r-bit long tag may be given by the probability mass function of a binomial distribution:

$$Pr ( Z = 𝓏 ) = ( \begin{matrix}r \\ 𝓏\end{matrix} ) {{p}^{k} ( 1 - p )}^{r - 𝓏} \qquad Equation 5$$

The probability p may be determined by analyzing the accumulation process. The probability of a_{i,j} being zero (0) after applying bit length transformation αᵣ may be 2^{-d}, Pr(a_{i,j}=1)=1−2^{-d}. Considering one bit of multicast MAC tag Tgᵢ that accumulates individual multicast MAC tags for m multicast destinations:

$$p = Pr ( {Tg}_{i} = 1 ) = {( 1 - {2}^{- d} )}^{m} , \qquad Equation 6$$

by substituting probability p to Equation 6, a probability mass function may be obtained as follows:

$$Pr ( Z = 𝓏 ) = ( \begin{matrix}r \\ 𝓏\end{matrix} ) {( 1 - {2}^{- d} )}^{m} {( 1 - {( 1 - {2}^{- d} )}^{m} )}^{r - 𝓏} \qquad Equation 7$$

Equation 7 is representative of a probability of z ones (1's) in multicast MAC tag Tg. A goal may be to find a lower bound on number of ones (1's). Given the probability of z or more ones (1's) in bit sequence of Tg is equal to 1 minus the probability of z or fewer ones (1's) (1−Pr (Z≤z)),

$$P ( Z > 𝓏 ) = 1 - {{\sum }_{i = 0}}^{𝓏} ( \begin{matrix}r \\ i\end{matrix} ) {( 1 - {2}^{- d} )}^{m} {( 1 - {( 1 - {2}^{- d} )}^{m} )}^{r - i} \qquad Equation 8$$

According to Equation 8, probability Pr(Z>z) depends on r, d, and m. The value of r may depend on security strength t. For particular configurations of a SoC (e.g., NoC size and cache coherence protocol) of multicast authentication to secure cache invalidations, the values of d and m may be fixed. For example, when using a modified exclusive shared invalid (MESI) protocol in a 4×4 mesh, the maximum possible m is 8 and d is 3. Therefore, the minimum value for z may depend on r.

A multicast MAC tag Tg′ that comprises a forged multicast MAC tag may be verified based on a lower bound of ones (1's). For example, a valid multicast MAC tag Tg may not have less than a min (z) of ones (1's). That is, a valid multicast MAC tag Tg may comprise z number of ones (1's). The probability of an arbitrary bit of multicast MAC tag Tg being one (1) may be expressed as Pr(Tgⱼ=1)=z/r. With respect to determining bit length transformation αᵣ of an i^{th} receiver, a probability of a_{i,j} to be 0 after applying αᵣ may be expressed as 2^{-d}(Pr(a_{i,j}=0)=2^{-d}). Thus, if Tg′ⱼ⊙(a_{i,j}≠Tg′ⱼ, the iₜₕ receiver may determine that the multicast MAC tag Tg′ is forged.

To successful forge the multicast MAC tag Tg, an attacker may be constrained to avoiding the aforementioned condition for all r bits. The probability of successfully forging P_{rforge} the multicast MAC tag Tg may be determined by the following:

$${Pr}_{forge} = 1 - {( {2}^{- d} \times \frac{𝓏}{r} )}^{r} = {( 1 - \frac{𝓏}{N \cdot r} )}^{r} \qquad Equation 9$$

For any real number, inequality 1+x≤e^{x} holds, and as such, for

$$x = - \frac{z}{N \times r} , 1 - \frac{z}{N \times r} \leq {e}^{- 𝓏 / Nr} .$$

By raising both sides to the power of r, the following may be obtained:

$${Pr}_{forge} = {( 1 - \frac{𝓏}{N \cdot r} )}^{r} \leq {e}^{- 𝓏 / N} \qquad Equation 10$$

For fixed N and security level t, a minimum number of ones (1's) in multicast MAC tag Tg, z, may be calculated using Equation 10. Equation 8 may be used to calculate respective r values. Table 1 provides example r and z values for increasing t values for N=8.

TABLE I

| Security | Minimum ones | Minimum tag |
|---|---|---|
| level (t) | (1's) in tag (z) | length (r) |
| 4 | 32 | 128 |
| 6 | 48 | 196 |
| 8 | 64 | 262 |
| 10 | 80 | 330 |
| 15 | 120 | 500 |
| 20 | 160 | 672 |

### Example Pipelined Multicast Authentication

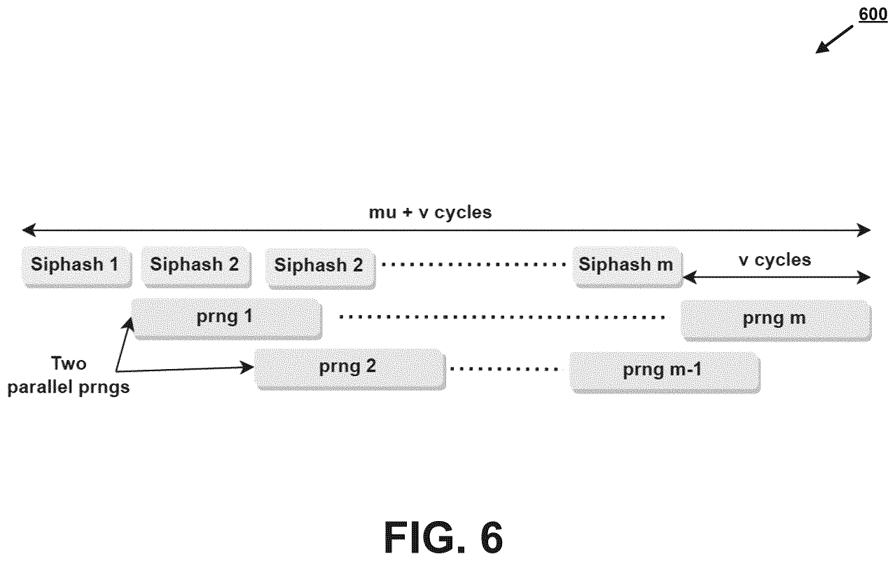

As discussed herewith, the length of a second-format tag resulting from performing a bit extension operation on a first-format tag may be relatively high. For example, when N=8 and t=10, the value of/may be 652 bits. Accordingly, generating a second-format tag may require more cycles than generating a first-format tag (e.g., using SipHash). Therefore, two pseudorandom number generators working simultaneously in a pipelined manner may be used as depicted in FIG. 6.

FIG. 6 depicts an example architecture 600 for pipelining operations associated generating a first-format tag and a second-format tag in accordance with some embodiments of the present disclosure. As depicted in FIG. 6, hash (e.g., SipHash) generation for first-format tags and bit extension of the first-format tags for generating second-format tags may be streamlined by pipelining two parallel pseudorandom number generators that are staged with every other hash generating cycle. A u number of cycles are used for generating a first-format tag and a v number of cycles are used for generating a second-format tag, where u<v. When there are m multicast recipients, a total of mu+v+1 cycles may be used for generating a multicast MAC tag compared with a non-pipelined approach that may use u+mv+1 cycles.

### Conclusion

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A method for securing multicast communications, the method comprising:
receiving, by one or more processors, a message payload;
initializing, by the one or more processors, a multicast message authentication code (MAC) tag;
generating, by a network interface, a first-format tag based on a hash of a pre-shared symmetric key and the message payload;
generating, by the network interface, a second-format tag based on a bit extension of the first-format tag;
generating, by the network interface, a transformed tag based on a bit length transformation of the second-format tag;
accumulating, by the network interface, the transformed tag to the multicast MAC tag; and
generating, by the network interface, a multicast authenticated packet based on the multicast MAC tag.

2. The method of claim 1, wherein the message payload comprises a cache invalidation message.

3. The method of claim 1, wherein initializing the multicast MAC tag comprises generating a bit string of length r, wherein the bit string comprises a sequence of ones.

4. The method of claim 1, wherein the multicast MAC tag comprises an accumulated hash.

5. The method of claim 1, wherein the multicast MAC tag comprises a one-way hash function with a quasi-commutative property.

6. The method of claim 1, wherein the multicast MAC tag comprises a fast variant of a one-way accumulator.

7. The method of claim 1, wherein the hash comprises a keyed hash function.

8. The method of claim 1, wherein the pre-shared symmetric key is associated with a multicast sender and a multicast receiver.

9. The method of claim 1, wherein generating the second-format tag further comprises extending the first-format tag by mapping the first-format tag to the second-format tag based on one or more values that are generated by one or more pseudorandom number generators.

10. The method of claim 1, wherein generating the transformed tag further comprises replacing all-zero sub-strings in the second-format tag with 0 and replacing non-all-zero sub-strings in the second-format tag with 1.

11. The method of claim 1, wherein accumulating the transformed tag to the multicast MAC tag further comprises applying a bitwise logical and operation.

12. The method of claim 1, wherein accumulating the transformed tag to the multicast MAC tag further comprises combining the transformed tag with a plurality of transformed tags that are associated with a plurality of multicast receivers.

13. The method of claim 12, wherein combining the transformed tag with the plurality of transformed tags further comprises generating a collective product of the transformed tag and the plurality of transformed tags.

14. The method of claim 1, wherein generating the multicast authenticated packet comprises concatenating the message payload with the multicast MAC tag.

15. A method for verifying authenticity of multicast communications, the method comprising:
parsing, by a network interface, a message payload and a multicast message authentication code (MAC) tag from a multicast authenticated packet;
generating, by the network interface, a first-format tag based on a hash of a pre-shared symmetric key and the message payload;
generating, by the network interface, a second-format tag based on a bit extension of the first-format tag;
generating, by the network interface, a transformed tag based on a bit length transformation of the second-format tag; and
determining, by the network interface, authenticity of the multicast authenticated packet based on a comparison of an accumulation comprising the transformed tag and the multicast MAC tag with the multicast MAC tag.

16. The method of claim 15, wherein determining the authenticity of the multicast authenticated packet further comprises determining the multicast authenticated packet is valid based on a presence of the accumulation in the multicast MAC tag.

17. The method of claim 15, wherein determining the authenticity of the multicast authenticated packet further comprises determining the multicast authenticated packet is invalid.

18. A multicast authentication system, comprising:
a system-on-chip device comprising:
a source node configured to generate one or more message payloads;
a tag generator configured to generate one or more multicast authenticated packets based on the one or more message payloads and a pre-shared symmetric key;
a network-on-chip comprising one or more routers;
one or more destination nodes; and
one or more tag verifiers configured to (i) receive the one or more multicast authenticated packets via the one or more routers, (ii) verify the one or more multicast authenticated packets, and (iii) provide the verified one or more multicast authenticated packets to the one or more destination nodes.

19. The multicast authentication system of claim 18, wherein the one or more message payloads comprise one or more cache invalidation messages.

20. The multicast authentication system of claim 18, wherein the one or more multicast authenticated packets comprise one or more multicast message authentication code (MAC) tags.
